(19) United States
(12) Patent Application Publication
(10) Pub. No.: US 2010/0183456 A1
(43) Pub. Date: Jul. 22, 2010

(54) MICRO-FLUIDIC SYSTEM

(75) Inventors: Jacob Marinus Jan Den Toonder, Eindhoven (NL); Lucas Van Rijsewijk, Eindhoven (NL); Dirk Jan Broer, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/376,641

(22) PCT Filed: Aug. 8, 2007
(86) PCT No.: PCT/IB07/53141

§ 371 Date: Feb. 6, 2009

(30) Foreign Application Priority Data
Aug. 9, 2006 (EP) 06118685.4

(51) Int. Cl. F04B 35/04; B23P 15/00

(52) U.S. Cl. 417/410.1; 29/888.02

(57) ABSTRACT

The present invention provides a micro-fluidic system, a method for manufacturing a micro-fluidic system and a method for controlling or manipulating a fluid flow through micro-channels of such a micro-fluidic system. The inner side of the wall of the micro-channel is provided with actuator elements. These actuator elements have a shape, an orientation and a geometry that includes a varying cross sectional area along a longitudinal axis. The varying cross sectional area includes one or more openings along the longitudinal axis of the actuator element. The actuator elements can change in shape and orientation as a response to an external stimulus. Through this change of the shape and orientation, the flow of a fluid through a micro-channel may be controlled and manipulated.

### FIELD OF THE INVENTION

The present invention relates to a micro-fluidic system, to a method for manufacturing such a micro-fluidic system and to a method for controlling or manipulating a fluid flow through micro-channels of such a micro-fluidic system.

### BACKGROUND OF THE INVENTION

Micro-fluidic systems are becoming a key foundation to many of today's fast-growing biotechnologies, such as rapid DNA separation and sizing, cell manipulation, cell sorting and molecule detection. Micro-fluidic chip-based technologies offer many advantages over their traditional macro-sized counterparts.

In all micro-fluidic devices, there is a basic need for controlling the fluid flow, that is, fluids must be transported, mixed, separated and directed through a micro-channel system consisting of channels with a typical width of about 0.1 mm. A challenge in micro-fluidic actuation is to design a compact and reliable micro-fluidic system for regulating or manipulating the flow of complex fluids of variable composition, e.g. saliva and full blood, in micro-channels. Various actuation mechanisms have been developed and are used at present, such as pressure-driven schemes, micro-fabricated mechanical valves and pumps, inkjet-type pumps, electro-kinetically controlled flows, and surface-acoustic waves.

In US 2003/0231967, a micro-pump assembly is provided for use in a micro-gas chromatograph and the like, for driving a gas through the chromatograph. This is an example of a membrane-displacement pump, wherein deflection of micro-fabricated membranes provides the pressure work for the pumping of liquids. A disadvantage, however, of using such a micro-pump assembly and of using micro-pumps in general, is that they have to be, in some way, integrated into micro-fluidic systems. This means that the size of the micro-fluidic systems will increase. It would therefore be useful to have a micro-fluidic system which is compact and cheap, and nevertheless easy to process.

It is an object of the present invention to provide an improved micro-fluidic system and a method of manufacturing and operating the same. Advantages of the present invention can be at least one of being compact, cheap and easy to process.

The above objective is accomplished by a method and device according to the present invention.

### SUMMARY OF THE INVENTION

In a first aspect, the present invention provides a micro-fluidic system comprising at least one micro-channel having a wall with an inner side, and furthermore comprising:

a plurality of actuator elements attached to the inner side of the wall, each actuator element having a shape, an orientation and a geometry that includes a varying cross sectional area along a longitudinal axis; and

means for applying stimuli to the plurality of actuator elements so as to cause a change in their shape and/or orientation.

Application of stimuli to the plurality of actuator elements provides a way to locally manipulate the flow of complex fluids in a micro-fluidic system. The actuator elements may be driven or addressed individually or in groups to achieve specific ways of fluid flow. The geometry of the actuator elements includes a varying cross sectional area along a longitudinal axis. The varying cross sectional area of the actuator elements reduces the compliance of the actuator elements compared to those with a uniform cross sectional area. Unless the compliance of the actuator is low, the stimuli required to overcome the stiffness of the actuators and to significantly deform them, may become unacceptably large.

In an embodiment according to the invention, the varying cross sectional area is substantially towards the inner side of the wall of the micro-channel. The varying cross sectional area is preferably a decreasing cross sectional area. The decreasing cross sectional area is 10-80% of the cross sectional area of the actuator element. The actuator element with thinner cross sectional area acts as a hinge and the stimuli needed to cause a change in the shape or orientation is orders of magnitude lower than that needed for an actuator element having a uniform cross sectional area.

In a specific embodiment according to the present invention, the micro-fluidic system comprises a means for applying stimuli to the plurality of actuator elements. The means for applying a stimulus to the plurality of actuator elements could be an electric field generating means (e.g. a current source or an electrical potential source), an electromagnetic field generating means (e.g. a light source), an electromagnetic radiation means (e.g. a light source), an external or internal magnetic field generating means.

In a most preferred embodiment according to the present invention, the means for applying a stimulus to the actuator elements is a magnetic field generating means.

In one embodiment according to the invention, the plurality of actuator elements may be arranged in a first and a second row, the first row of actuator elements being positioned at a first position of the inner side of the wall and the second row of actuator elements being positioned at a second position of the inner side of the wall, the first position and the second position being substantially opposite to each other.

In another embodiment of the present invention, the plurality of actuator elements may be arranged in a plurality of rows of actuator elements which are arranged to form a two-dimensional array.

In a further embodiment of the present invention, the plurality of actuator elements may be randomly arranged at the inner side of the wall of a micro-channel.

In a second aspect according to the invention, a method for manufacturing a micro-fluidic system having at least one micro-channel includes

providing an inner side of a wall of at least one micro-channel with a plurality of actuator elements with a geometry that includes a varying cross sectional area along a longitudinal axis; and

providing means for applying a stimulus to said plurality of actuator elements.

The method of forming the plurality of actuator elements with the aforementioned geometry is performed by:

depositing a sacrificial layer having a length L on the inner side of the wall;

depositing an actuator material on top of said sacrificial layer; and

releasing the actuator material from the inner side of the wall by removing the sacrificial layer.

Removing the sacrificial layer may be performed by an etching step.

According to an embodiment of the invention, the means for applying a stimulus to the actuator elements may include providing a magnetic or electric field-generating means.

In a further aspect of the present invention, a method for controlling a fluid flow through a micro-channel of a micro-fluidic system is provided. The micro-channel has a wall with an inner side. The method comprises:

providing the inner side of the wall with a plurality of actuator elements, the actuator elements each having a shape, an orientation and a geometry that includes a varying cross sectional area along a longitudinal axis; and

applying a stimulus to the actuator elements so as to cause a change in their shape and/or orientation.

In a specific embodiment according to the invention, applying a stimulus to the actuator elements may be performed by applying a magnetic field.

The present invention also includes, in a further aspect, a micro-fluidic system comprising at least one micro-channel having a wall with an inner side and containing a liquid, and further comprising:

a plurality of actuator elements attached to the inner side of the wall; and

means for applying stimuli to the plurality of actuator elements so as to drive the liquid in a direction along the micro-channel.

The micro-fluidic system according to the invention may be used in biotechnological, pharmaceutical, electrical or electronic applications. In biotechnological applications, micro-fluidic systems are used in biosensors, in rapid DNA separation and sizing, in cell manipulation and sorting. In pharmaceutical applications, micro-fluidic systems are used in high-throughput combinatorial testing where local mixing is essential. In electrical or electronic applications, micro-fluidic systems are used in micro-channel cooling systems.

The micro-fluidic system according to the invention may be used in a diagnostic device, such as a bio sensor, for the detection of at least one target molecule, such as proteins, antibodies, nucleic acids (e.g. DNA, RNA), peptides, oligo- or polysaccharides or sugars, in biological fluids, such as saliva, sputum, blood, blood plasma, interstitial fluid or urine.

These and other characteristics, features and advantages of the present invention will become apparent from the following detailed description, taken in conjunction with the accompanying drawings, which illustrate, by way of example, the principles of the invention. This description is given by way of example only, without limiting the scope of the invention. The reference numerals quoted below refer to the attached drawings.

### DESCRIPTION OF THE FIGURES

FIG. 1 illustrates a prior-art micro-pump assembly;

FIG. 2 is a schematic representation of an actuator element with a geometry that includes a varying cross sectional area along a longitudinal axis, according to an embodiment of the invention;

FIG. 3 is a schematic representation of an actuator element with a geometry that includes a varying cross sectional area along a longitudinal axis, according to another embodiment of the invention;

FIG. 4 illustrates a bending polymer MEMS structure according to an embodiment of the invention;

FIG. 5 is a schematic illustration of cross-sections of a micro-channel having the inner side of its wall covered with straight actuator elements, according to an embodiment of the invention;

FIG. 6 is a schematic illustration of cross-sections of a micro-channel having the inner side of its wall covered with actuator elements that curl up and straighten out, according to another embodiment of the invention;

FIG. 7 is a schematic illustration of cross-sections of a micro-channel having the inner side of its wall covered with actuator elements that move back and forth asymmetrically, according to still another embodiment of the invention;

FIG. 8 illustrates the application of a uniform magnetic field to a straight actuator element, according to an embodiment of the present invention;

FIG. 9 illustrates the application of a rotating magnetic field to individual actuator elements, according to a further embodiment of the present invention; and

FIG. 10 illustrates the application of a non-uniform magnetic field, using a conductive line to apply a force to an actuator element, according to a further embodiment of the present invention.

In the different Figures, the same reference signs refer to the same or analogous elements.

### DETAILED DESCRIPTION OF THE INVENTION

Particular and preferred aspects of the invention are set out in the accompanying independent and dependent claims. Features of the dependent claims may be combined with features of the independent claims and with features of other dependent claims, as appropriate and not merely as explicitly set out in the claims.

The present invention will be described with respect to particular embodiments and with reference to certain drawings, but the invention is not limited thereto but only by the claims. Any reference signs in the claims shall not be construed as limiting the scope. The drawings described are only schematic and are non-limiting. In the drawings, the size of some of the elements may be exaggerated, and not drawn to scale, for illustrative purposes. Where the term “comprising” is used in the present description and claims, it does not exclude other elements or steps. Where an indefinite or definite article is used when referring to a singular noun e.g. “a” or “an”, “the”, this includes a plural of that noun unless something else is specifically stated.

Furthermore, the terms first, second, third and the like in the description and in the claims, are used for distinguishing between similar elements and not necessarily for describing a sequential or chronological order. It is to be understood that the terms so used are interchangeable under appropriate circumstances and that the embodiments of the invention described herein are capable of operation in other sequences than described or illustrated herein.

Moreover, the terms top, bottom, over, under and the like in the description and the claims are used for descriptive purposes and not necessarily for describing relative positions. It is to be understood that the terms so used are interchangeable under appropriate circumstances and that the embodiments of the invention described herein are capable of operation in other orientations than described or illustrated herein.

Hereinafter, the term shape means the shape of an actuator element that may be beam or rod-shaped or of any other suitable shape including an elongated shape. The term orientation means the orientation of an actuator element that may be perpendicular to or in-plane with the inner side of the wall of the micro-channel. The term compliance means the inverse of stiffness or, in other words, the more compliant the actuator element; the less stiff it is when actuated by external stimuli. The geometry of the actuator elements according to the invention includes a varying cross sectional area of the actuator element, which is preferably thinner towards the inner side of the wall of the micro-channel. The decreasing cross sectional area is 10-80% of the cross sectional area of the actuator element. The decrease in either thickness or width, resulting in varying cross sectional area of the actuator element, makes it compliant. In other words, this was found to result in reduced stiffness of the actuator elements. It will be appreciated that the compliance of the actuator element may also be influenced by using a material with a low elastic modulus, thus increasing the compliance of the element.

In a first aspect, the present invention provides a micro-fluidic system provided with means which allow transportation or (local) mixing or directing of fluids through micro-channels of the micro-fluidic system. In a second aspect, the present invention provides a method for the manufacturing of such a micro-fluidic system. In a third aspect, the present invention provides a method for controlling fluid flow through micro-channels of a micro-fluidic system. The micro-fluidic system according to the invention was found to be economical and simple to process, while also being robust and compact and suitable for very complex fluids.

A micro-fluidic system according to the invention comprises at least one micro-channel and micro-fluidic elements integrated at an inner side of a wall of the at least one micro-channel. The micro-fluidic elements are the actuator elements. These elements are preferably compliant and tough. The actuator elements preferably respond to a certain stimulus, such as an electric field, a magnetic field, etc., by bending or rotating or changing shape. The actuator elements are preferably easy to process by means of relatively cheap processes.

According to the invention, all suitable materials, i.e. materials that are able to change shape by mechanically deforming as a response to an external stimulus, may be used. The external stimulus may be of varying origin, such as an electric field, a magnetic field, light, temperature, chemical environment, etc. An overview of possible materials is given in Dirk J. Broer, Henk van Houten, Martin Ouwerkerk, Jaap M. J. den Toonder, Paul van der Sluis, Stephen I. Klink, Rifat A. M. Hikmet, Ruud Balkenende. Smart Materials. Chapter 4 in True Visions Tales on the Realization of Ambient Intelligence, ed. by Emile Aarts and José Encarnaçao, Springer Verlag, 2006. Polymer materials are, generally, tough instead of brittle, relatively cheap, elastic up to large strains (up to 10% or more) and offer the perspective of being processable on large surface areas, using simple processes.

Depending on the type of actuation stimulus, the material that is used to form the actuator elements may have to be functionalized. Polymers are preferred for at least a part of the actuators. Most types of polymers can be used according to the present invention, except for very brittle polymers such as polystyrene, which are not very suitable for use in the present invention. In some cases, for example in the case of electrostatic or magnetic actuation, metals may be used to form the actuator elements or may be part of the actuator elements, e.g. in Ionomeric Polymer-Metal composites (IPMC). For example, for magnetic actuation, FeNi or another magnetic material may be used to form the actuator elements. A disadvantage of metals, however, could be mechanical fatigue and cost of processing.

Other materials that may be used include all forms of Electro-active Polymers (EAPs). They may be classified very generally into two classes: ionic and electronic. Electronically activated EAPs include any of the following: electrostrictive (e.g. electrostrictive graft elastomers), electrostatic (dielectric), piezoelectric, magnetic, electrovisco-elastic, liquid crystal elastomer, and ferroelectric actuated polymers. Ionic EAPs include gels such as ionic polymer gels, Ionomeric Polymer-Metal Composites (IPMC), conductive polymers and carbon nanotubes. The materials may exhibit conductive or photonic properties, or be chemically activated, i.e., non-electrically deformable. Any of the above EAPs can be made to bend with a significant curving response and can be used for the actuator elements with the geometry according to the invention.

Because of the above, according to the present invention, the actuator elements may preferably be formed of, or include as a part of their construction, polymer materials. Therefore, in the further description, the invention will be described by means of polymer actuator elements. It has, however, to be understood by a person skilled in the art that the present invention may also be applied when materials other than polymers, as described above, are used to form the actuator elements. Polymer materials are, generally, tough instead of brittle, relatively cheap, elastic up to large strains (up to 10%) and offer the perspective of being processable on large surface areas, using simple processes.

The micro-fluidic system according to the invention may be used in biotechnological applications, such as micro total analysis systems, micro-fluidic diagnostics, micro-factories and chemical or biochemical micro-plants, biosensors, rapid DNA separation and sizing, cell manipulation and sorting, in pharmaceutical applications, in particular high-throughput combinatorial testing, where local mixing is essential, and in micro-channel cooling systems, e.g. in micro-electronics applications.

The present invention manipulates the fluid motion in micro-channels by covering the walls of the micro-channels with microscopic polymer actuator elements, i.e. polymer structures changing their shape and/or dimension in response to a certain external stimulus. In the following description, these microscopic actuator elements, such as polymer actuator elements, may also be referred to as actuators, e.g. polymer actuators or micro-polymer actuators, actuator elements, micro-polymer actuator elements or actuator elements. It has to be noted that when any of these terms are used in the further description, always the same microscopic actuator elements according to the invention are meant. The micro-polymer actuator elements or polymer actuators can be set in motion, either individually or in groups, by any suitable external stimuli. These external stimuli may be an electric field such as e.g. a current, a magnetic field, or any other suitable means.

However, for biomedical applications, considering possible interactions with the complex biological fluids that may occur, electric and magnetic actuation means may be preferred, using other materials to form the actuator elements.

In the description, mainly magnetic actuation will be discussed. An individual magnetically actuated polymer element is basically a flap that is either paramagnetic or ferromagnetic. This can be achieved by incorporating super-paramagnetic or ferromagnetic particles in the flap, or depositing a (structured) magnetic layer on the flap, or using intrinsically magnetic polymer materials. The flap can be moved in a magnetic field, either by an effectively applied torque, or by a direct translational force. The field may be either uniform or a spatially varying one which is, for example, induced by a current wire.

The application of an external magnetic field will result in translational as well as rotational forces on the flap. The translational force equals:

\vec{F}=∇(\vec{m}·\vec{B}), (1)

where \vec{m} is the magnetic moment of the flap and \vec{B} is the magnetic induction.

The rotational force, i.e. the torque on the flap, will cause it to move, i.e. rotate and/or change shape. Assuming a magnetic moment of the flap of \vec{m} and a magnetic field strength of \vec{H}, the torque \vec{τ} is given by:

\vec{τ}=μ\vec{m}×\vec{H}=\vec{m}×\vec{B}=V\vec{M}×\vec{B}=Lwt\vec{M}×\vec{B} (2)

where μ is the permeability, \vec{B} is the magnetic induction, \vec{M} is the magnetization (i.e. the magnetic moment per unit volume), and V is the volume of the flap. The flap has length×width×thickness dimensions of L×w×t. The applied torque depends on the angle between the magnetic moment and the magnetic field, and is zero when these are aligned.

To get an effective element for use in a micro-fluidic device, the resulting force acting on the flap must, on the one hand, be sufficient to deform the flap significantly (i.e. overcome the stiffness of the flap), and on the other hand, be large enough to exceed the drag acting upon the flap by the surrounding fluid.

In a magnetic field, the flap will experience a torque given by equation (2), which is:

τ=LwtMB sin α (3)

where M is the magnetization of the flap, which is assumed to be oriented along the length direction of the flap. B is the magnitude of the applied magnetic induction, and α is the angle between the magnetization and the applied magnetic field. The torque can be represented as a force F acting on the tip of the flap, by the equation:

$$F = \frac{τ}{L} = wtMB sin α \qquad ( 4 )$$

If the material has a Young's modulus E, the deflection δ of its tip, when a load F is acting on it, is given by:

$$δ = \frac{4 {L}^{3} F}{{Ewt}^{3}} \qquad ( 5 )$$

This formula is valid for fairly small deflections, i.e. in the order of the thickness of the element. For larger deflections, needed for effective fluid actuation, non-linear effects that are not included in equation (5) need to be taken care of The Finite Element Method (FEM), as implemented in the FEM package “Ansys”, is used to compute the force-deflection relation.

A typical force needed to deflect the flap about 5 μm would be approximately 0.1 μN, when E=2 GPa, L=20 μm, w=10 μm, and t=300 nm. The required magnetic field to get this force is estimated from equation (4). It is assumed that the structure is filled with 10 vol % ferromagnetic magnetite particles. The magnetization of bulk magnetite is about 5×10⁵ A/m. Since the particles are spherical, the effective magnetization must be multiplied by a shape factor equal to ⅓. Hence, the effective magnetization of the flap equals M=10%×(⅓)×5×10⁵=1.65×10⁴ A/m. Substituting values in equation (4), and assuming the optimal orientation of the flap, i.e. perpendicular to the magnetic field, it follows that for a force of 0.1 μN, a magnetic induction of 2 T is needed. This is an unrealistically large value for practical applications.

When using the magnetic field gradient, and hence the translational force given by equation (1), in combination with a super-paramagnetic flap, a similar argument applies. Unless the compliance of the flaps is high, the field gradients/electric current required to overcome the stiffness of the flaps and to significantly deform them, become unacceptably large.

According to the invention, the actuator elements have a varying cross sectional area along a longitudinal axis. The varying cross section may include openings. The shape of the openings may be a square, a rectangle, a circle, a semi-circle and/or the like. These openings decrease the stiffness of the actuator elements. It is to be noted that the decrease in either thickness or width of the actuator elements makes them more compliant. Without wishing to be bound by any theory, it is believed that the part of the actuator element with reduced thickness or width acts as a hinge and the stimuli needed to cause a change in the shape or orientation is orders of magnitude lower than that needed for an actuator element having a uniform cross sectional area. The compliance was found to increase linearly with a decrease in width, whereas it increases with the thickness to the power three.

According to another embodiment, the actuator elements have multiple openings, such as multiple compliant hinges. These may be obtained by either reducing the width or the thickness of the actuator elements. These structures are capable of providing more complex movements. However, it can be seen from equation (2) that lowering the thickness or width can result in reduced magnetic force. Whether the multiple compliant hinges are more effective, depends on the balance between reduced stiffness and reduced magnetic force. This preferred embodiment may work best for magnetic stimuli. However, it should not limit the scope of the invention to only magnetic fields.

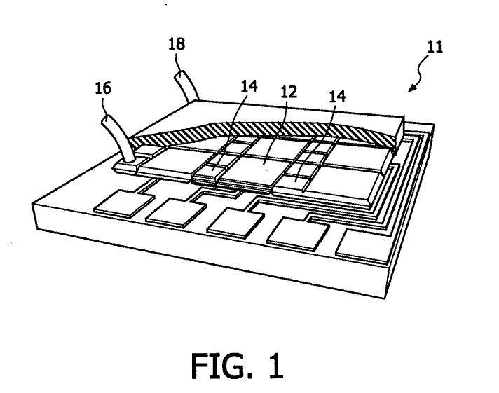

FIG. 1 illustrates a prior art micro-pump assembly. A micro-pump assembly 11 is provided for use in a micro-gas chromatograph and the like, for driving a gas through the chromatograph. The micro-pump assembly 11 includes a micro-pump 12 having a series arrangement of micro-machined pump cavities, connected by micro-valves 14. A shared pumping membrane divides the cavity into top and bottom pumping chambers. Both of the pumping chambers are driven by the shared pumping membrane, which may be a polymer film. Movement of the pumping membrane and control of the shared micro-valve are synchronized to control flow of fluid through the pump unit pair in response to a plurality of electrical signals.

The assembly 11 furthermore comprises an inlet tube 16 and an outlet tube 18. The pumping operation is thus triggered electrostatically by pulling down pump and valve membranes according to a certain cycle. By scheduling the electrical signal in a specific way, gas can be sent in one direction or the reverse direction. The frequency at which the pump system is driven determines the flow rate of the pump. By having electrodes on both sides, an electrostatically driven membrane easily overcomes mechanical limitations of vibration and damping from resistant air movement throughout holes and cavities.

The micro-pump assembly 11 of US 2003/0231967 is an example of a membrane-displacement pump, wherein deflection of micro-fabricated membranes provides the pressure necessary for the pumping of liquids.

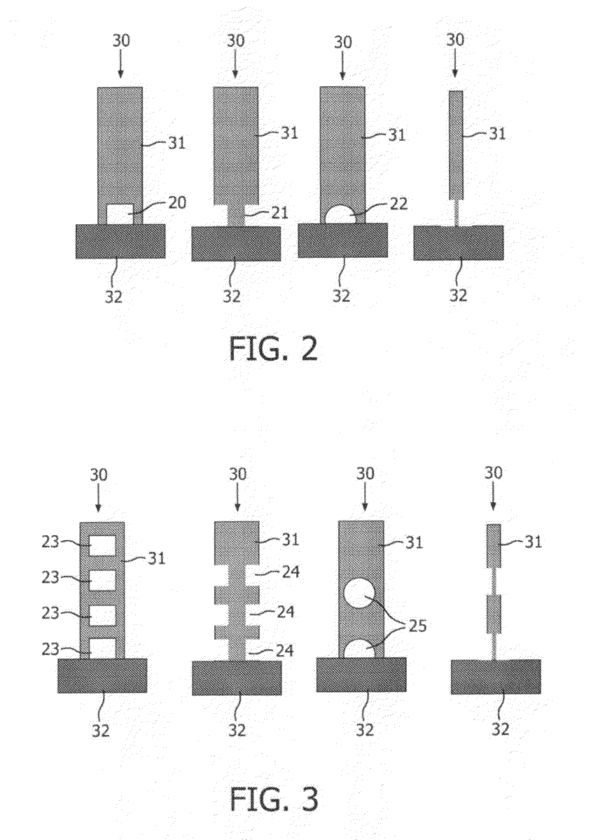

FIG. 2 and FIG. 3 illustrate an example of an actuator element 30 with the geometry according to an embodiment of the present invention. The Figure on the right in FIG. 2 and FIG. 3 shows a side view of the actuator element. These Figures represent an actuator element 30 which may respond to an external stimulus, such as an electric or magnetic field or another stimulus, by bending up and down. The polymer actuator element 30 comprises a polymer Micro-Electro-Mechanical System (polymer MEMS) 31 and an attachment means 32 for attaching the polymer MEMS 31 to a micro-channel 33 of the micro-fluidic system. The attachment means 32 can be positioned at a first extremity of the polymer MEMS 31. The polymer MEMS 31 may have the shape of a beam or a rod. However, the invention is not limited to beam or rod-shaped MEMS. The actuator element 30 may comprise a varying cross sectional area along a longitudinal axis to increase the compliance or, in other words, reduce the stiffness of the actuator element. The varying cross section may include openings 20, 21, 22 as shown in FIG. 2. The shape of the openings may be a square, a rectangle, a circle, a semi-circle and/or the like. The actuator elements 30 have multiple openings 23, 24, 25, such as multiple compliant hinges as shown in FIG. 3. The actuator element 30 may also comprise polymer MEMS 31 having other suitable shapes.

According to the above-described aspect of the invention, the polymer MEMS 31 may have a length ‘l’ in the range of about 10 to 100 μm, typically 20 μm. They may have a width ‘w’ in the range of about 2 to 30 μm, typically 10 μm. The polymer MEMS 31 may have a thickness ‘t’ in the range of about 0.1 to 2 μm, typically 0.3 μm. The length/width/diameter of the openings may be in the range of 1-5 μm, typically 2 μm. Although, in FIG. 2 and FIG. 3, an orientation perpendicular to the substrate surface is sketched, the initial orientation may also be in-plane with the surface.

Actuator elements formed of materials which can respond to temperature changes, visible and UV light, water, molecules, electrostatic fields, magnetic fields, electric fields, may be used according to the invention. However, for biomedical applications, for example, light- and magnetic-actuation means may be preferred, considering possible interactions with the complex biological fluids, that may occur if other materials are used to form the actuator elements.

In the description, mainly magnetic actuation will be discussed. However, it has to be understood that also other stimuli may be used according to the present invention. For example, electrical stimuli, temperature changes and light. An example of a polymer material that may be used for forming actuator elements which are electrically stimulated may be a ferroelectric polymer, i.e. polyvinylidene fluorine (PVDF). Generally, all suitable polymers with low elastic stiffness and high dielectric constant may be used to induce a large actuation strain by subjecting them to an electric field. Other suitable polymers may for example be Ionomeric Polymer-Metal Composite (IPMC) materials or e.g. perfluorsulfonate and perfluorcarbonate. Examples of temperature-driven polymer materials may be shape memory polymers (SMP's), such as thermally responsive gels, e.g. Poly(N-isopropylacrylamide)

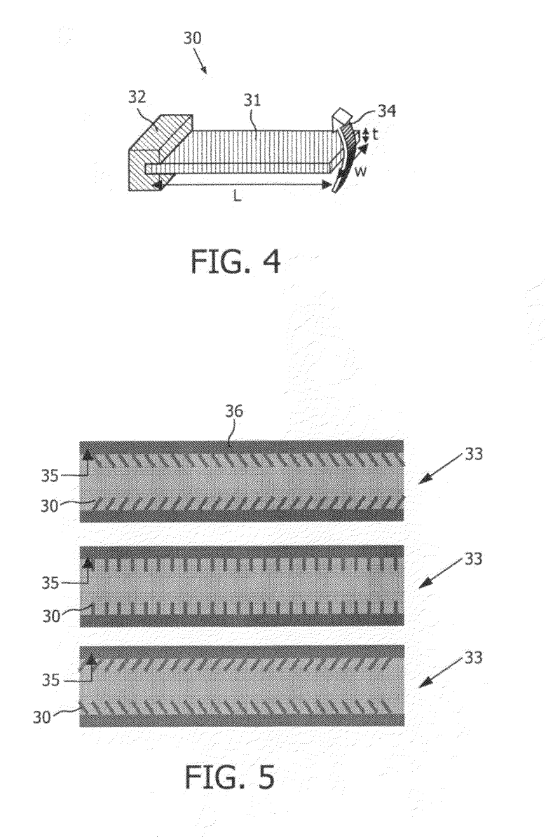

FIG. 4 illustrates an example of an actuator element 30 according to an embodiment of the present invention. The actuator element 30 may respond to an external stimulus, such as e.g. an electric or magnetic field or another stimulus, by bending up and down. The polymer actuator element 30 comprises a polymer Micro-Electro-Mechanical System or polymer MEMS 31 and an attachment means 32 for attaching the polymer MEMS 31 to a micro-channel 33 of the micro-fluidic system. The attachment means 32 can be positioned at a first extremity of the polymer MEMS 31.

The polymer MEMS 31 may have the shape of a beam. However, the invention is not limited to beam-shaped MEMS; the polymer actuator element 30 may also comprise polymer MEMS 31 having other suitable shapes, preferably elongate shapes, such as for example the shape of a rod.

An example of how to form an actuator element 30 attached to a micro-channel 33 according to the invention will be described hereinafter.

The actuator elements 30 may be fixed to the inner side 35 of the wall 36 of a micro-channel 33 in various possible ways. A first way to fix the actuator elements 30 to the inner side 35 of the wall 36 of a micro-channel 33 is by depositing, for example spinning, evaporation, or another suitable deposition technique, a layer of a material out of which the actuator elements 30 will be formed, on a sacrificial layer. Therefor, first a sacrificial layer may be deposited on an inner side 35 of a wall 36 of the micro-channel 33. The sacrificial layer may be composed of a metal (e.g. aluminum), an oxide (e.g. SiOx), a nitride (e.g. SixNy) or a polymer. The material the sacrificial layer is composed of should be such that it can be selectively etched with respect to the material the actuating element is formed of, and may be deposited on an inner side 35 of a wall 36 of the micro-channel 33 over a suitable length. In some embodiments, the sacrificial layer may be deposited over the whole surface area of the inner side 35 of the wall 36 of a micro-channel 33, typically areas in the order of several cm. However, in other embodiments, the sacrificial layer may be deposited over a length L, which length L may be the same as the length of the actuator element 30, which may typically be between 10 to 100 μm. Depending on the material used, the sacrificial layer may have a thickness between 0.1 and 10 μm.

In a next step, a layer of a polymer material, which will later form the polymer MEMS 31, is deposited over the sacrificial layer. Subsequently, the sacrificial layer may be etched wherever necessary to obtain the above-mentioned geometry of the actuator element. Thus, the polymer layer is released from the inner side 35 of the wall 36 over the length L (as illustrated in FIG. 4). This part forms the polymer MEMS 31. The part of the polymer layer that stays attached to the inner side 35 of the wall 36 forms the attachment means 32 for attaching the polymer MEMS to the micro-channel 33, more particularly to the inner side 35 of the wall 36 of the micro-channel 33.

Another way to form the actuator element 30 according to the present invention may be by using patterned surface energy engineering of the inner side 35 of the wall 36 before applying the polymer material. In that case, the inner side 35 of the wall 36 of the micro-channel 33 on which the actuator elements 30 will be attached is patterned in such a way that regions with different surface energies are obtained. This can be done with suitable techniques, such as lithography or printing. Therefor, the layer of material out of which the actuator elements 30 will be constructed is deposited and structured, using suitable techniques known by a person skilled in the art. The layer will adhere strongly to some areas of the inner side 35 of the wall 36 underneath, further referred to as strong adhesion areas, and weakly to other areas of the inner side 35 of the wall 36, further referred to as weak adhesion areas. It may then be possible to get a spontaneous release of the layer at the weak adhesion areas, whereas the layer will remain fixed at the strong adhesion areas. The strong adhesion areas may then form the attachment means 32. In that way it is thus possible to obtain self-forming free-standing actuator elements 30.

The as-processed elements 30 need not be in a direction substantially parallel to the channel wall 36, as is suggested in all the Figures of the present application.

The polymer MEMS 31 may, for example, comprise an acrylate polymer, a poly(ethylene glycol) polymer comprising copolymers, or may comprise any other suitable polymer. Preferably, the polymers used to form the polymer MEMS 31 should be biocompatible polymers, such that they have minimal (bio)chemical interactions with the fluid in the micro-channels 33 or the components of the fluid in the micro-channels 33. Alternatively, the actuator elements 30 may be modified so as to control non-specific adsorption properties and wettability. The polymer MEMS 31 may comprise a composite material. For example, it may comprise a particle-filled matrix material or a multilayer structure. It could also be mentioned that “liquid crystal polymer network materials” may be used in accordance with the present invention.

In a non-actuated state, i.e. when no external stimuli are applied to the actuator element 30, the polymer MEMS 31 which, in a specific example, may have the form of a beam, are either curved or straight. An external stimulus, such as an electric field (a current), electromagnetic radiation (light), a magnetic field, a temperature change, the presence of a specific chemical species, a pH change or any other suitable means, which is applied to the polymer actuator elements 30, causes them to bend or straighten out or, in other words, causes them to be set in motion. The change in shape of the actuator elements 30 sets the surrounding fluid, which is present in the micro-channel 33 of the micro-fluidic system, in motion. In FIG. 4, the bending of the polymer MEMS 31 is indicated by arrow 34.

FIG. 5 illustrates an embodiment of a micro-channel 33 provided with actuator elements according to the present invention. In this embodiment, an example of a design of a micro-fluidic system (excluding means for applying stimuli) is shown. A cross-section of a micro-channel 33 is schematically depicted. According to this embodiment of the invention, the inner sides 35 of the walls 36 of the micro-channels 33 may be covered with a plurality of straight polymer actuator elements 30. For the clarity of the drawings, only the polymer MEMS part 31 of the actuator element 30 is shown. The polymer MEMS 31 can move back and forth, under the action of an external stimulus applied to the actuator elements 30. This external stimulus may be an electric field, electromagnetic radiation, a magnetic field, or other suitable means. The actuator elements 30 may comprise polymer MEMS 31, which may e.g. have a rod-like shape or a beam-like shape, the width dimension of which extends in a direction away from the plane of the drawing.

The actuator elements 30 at the inner side 35 of the walls 36 of the micro-channels 33 may, in embodiments of the invention, be arranged in one or more rows. As an example only, the actuator elements 30 may be arranged in two rows of actuator elements 30, i.e. a first row of actuator elements 30 at a first position at the inner side 35 of the wall 36 and a second row of actuator elements 30 at a second position of the inner side 35 of the wall 36, the first and second position being substantially opposite to each other. In other embodiments of the present invention, the actuator elements 31 may also be arranged in a plurality of rows of actuator elements 30, which may be arranged to form a two-dimensional array. In still further embodiments, the actuator elements 30 may be randomly positioned at the inner side 35 of the wall 36 of a micro-channel 33.

To be able to transport a fluid in a certain direction, for example from the left to the right in FIG. 5, the movement of the actuator elements 30 may preferably be asymmetric. For a pumping device the motion of the polymer actuator elements is provided by a metachronic actuator means. This can be done by providing means for addressing the actuator elements 30 either individually or row by row. In the case of electrostatic actuation, this may be achieved by a patterned electrode structure that is part of a wall 36 of a micro-channel 33. The patterned electrode structure may comprise a structured film, which may be a metal or another suitable conductive film. Structuring of the film may be done by lithography. The patterned structures can be individually addressed. The same may be applied for magnetically actuated structures. Patterned conductive films that are part of the channel wall structure may make it possible to create local magnetic fields, so that actuator elements 30 can be addressed individually or in rows.

In all the above-described cases, individual or row-by-row stimulation of the actuator elements 30 is possible since the wall 36 of the micro-channel 33 comprises a structured pattern through which the stimulus is activated. Co-ordinated stimulation, in a wave-like manner, is made possible by proper addressing in time. Non-co-ordinated or random actuator means, symplectic metachronic actuator means and antiplectic metachronic actuator means are included within the scope of the present invention.

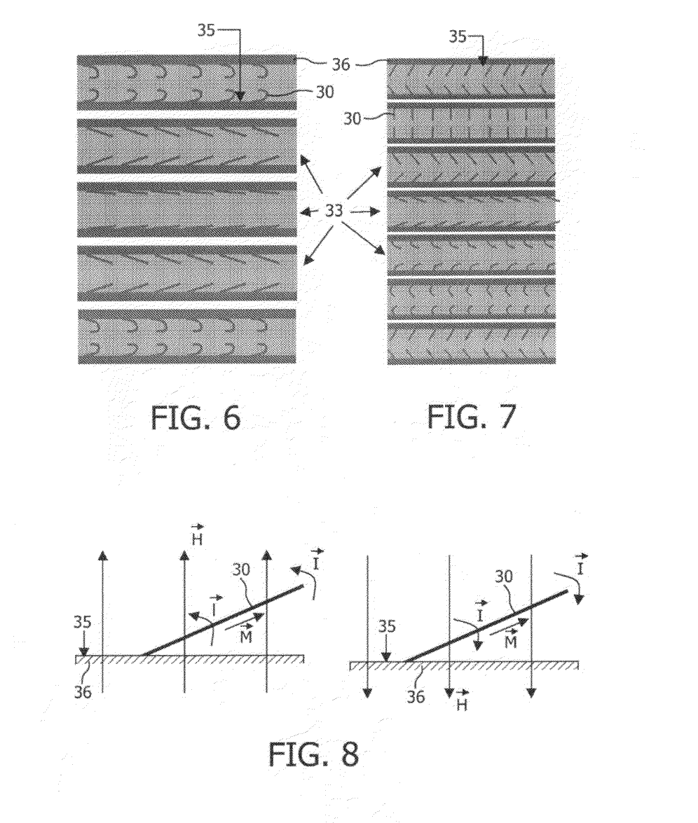

In the example shown in FIG. 5, all actuator elements 30, also those in different rows, move simultaneously. The functioning of the polymer actuators 30 may be improved by individual addressing of the actuator elements 30 or of the rows of actuator elements 30, so that their movement is out of phase. In electrically stimulated actuator elements 30, this may be performed by using patterned electrodes which may be integrated into the walls 36 of the micro-channel 33 (not shown in the drawing). Thus, the motion of actuator elements 30 appears as a wave passing over the inner side 35 of the wall 36 of the micro-channel 33, similar to the wave movement illustrated in FIG. 6. The means for providing the movement may generate a wave movement that may go in the same direction as the effective beating movement (“symplectic metachronism”) or in the opposite direction (“antiplectic metachronism”).

To obtain local mixing in a micro-channel 33 of a micro-fluidic system, the motion of the actuator elements 30 may be deliberately made uncorrelated, i.e. some actuator elements 30 may move in one direction whereas other actuator elements 30 may move in the opposite direction in a specific way so as to create local chaotic mixing. Vortices may be created by opposite movements of the actuator elements 30 at opposite positions of the walls 36 of the micro-channel 33.

A further embodiment of a micro-fluidic channel 33 provided with actuator elements 30 according to the present invention is schematically illustrated in FIG. 6. The inner side 35 of the walls 36 of the micro-channels 33 may, in this embodiment, be covered with actuator elements 30 that can be changed from a curled shape into a straight shape. This change of shape can be obtained in different ways. For example, a change of shape of the actuator element 30 can be obtained by controlling the microstructure of the actuator element 30, by introducing a gradient in the effective material stiffness over the thickness of the actuator element 30, causing the top of the actuator elements to be stiffer than the bottom. This can also be achieved by the composite structure of the actuator elements. This will cause “asymmetric bending”, i.e. the actuator element 30 will bend more easily in one direction than in the other. A change of the shape of the actuator element 30 may also be achieved by controlling the driving of the stimulus, such as a time- and/or space-dependent magnetic field in case of magnetic actuation. In this embodiment, an asymmetric movement of the actuator elements 30 may be obtained, which may be further enhanced by moving fast in one direction and slow in the other, e.g. a fast movement from the curled to the straight shaped and a slow movement from the straight to the curled shape, or vice versa. The polymer actuator elements 30 adapted for changing shape may comprise polymer MEMS 31 with e.g. a rod-like shape or a beam-like shape. The actuator elements 30 may, according to embodiments of the invention, be arranged in one or more rows, e.g. a first and a second row at the inner side 35 of the wall 36 of the micro-channel 33, the first and second row being positioned at substantially opposite positions at the inner side 35 of the wall 36. In other embodiments of the invention, the actuator elements 30 may be positioned in a plurality of rows of actuator elements 30 which may be arranged to form, for example, a two-dimensional array. In still further embodiments of the invention, the actuator elements 30 may be randomly arranged at the inner side 35 of the wall 36 of a micro-channel 36. By individually addressing the actuator elements 30 or a row of actuator elements 30, a wave-like movement, an otherwise correlated movement, or an uncorrelated movement may be generated that can be advantageous in transporting or mixing fluids, or creating vortices, all inside the micro-channel 33.

A further embodiment of the present invention is illustrated in FIG. 7. The inner side 35 of the walls 36 of the micro-channel 33 may, in this embodiment, be covered with actuator elements 30 that undertake an asymmetric movement. This may be achieved by inducing a change of molecular order in the actuator elements 30 from one side to the other. In other words, a gradient in the material structure over the thickness ‘t’ of the actuator elements 30 is obtained. This gradient may be achieved in various ways. In the case of liquid crystal polymer networks, the orientation of the liquid crystal molecules can be varied from top to bottom of the layers by controlled processing, for example by using a process which is used for, amongst others, liquid crystal (LC) display processing. Another possible way to achieve such a gradient is by building, or depositing, the layer forming the actuator element 30 from different materials of varying stiffness.

The asymmetric movement may be further enhanced by moving fast in one direction and slow in the other. The actuator elements 30 may comprise polymer MEMS 31 with an elongate shape, such as a rod-like shape or a beam-like shape. The actuator elements 30 may, in embodiments of the invention, be arranged at the inner side 35 of the walls 36 in one or more rows, e.g. in a first and a second row, for example one row of actuator elements 30 at each of two substantially opposite positions on the inner side 35 of the wall 36. In other embodiments of the present invention, a plurality of rows of actuator elements 30 may be arranged to form a two-dimensional array. In still further embodiments, the actuator elements 30 may be randomly arranged at the inner side 35 of the wall 36 of a micro-channel 33. By individual addressing of the actuator elements 30 or by individual addressing of rows of actuator elements 30, a wave-like movement, an otherwise correlated movement, or an uncorrelated movement may be generated that can be advantageous in transporting and mixing of fluid, or in creating vortices.

In FIG. 5 to FIG. 7, three examples of possible designs of micro-fluidic systems according to embodiments of the present invention are shown, which illustrate embodiments using actuator elements 30 integrated on the inner side 35 of the walls 36 of micro-channels 33 to manipulate fluid in micro-channels 33. It should, however, be understood by a person skilled in the art that other designs are conceivable and that the specific embodiments described are not limiting to the invention.

An advantage of the approach according to the present invention is that the means which takes care of fluid manipulation is completely integrated in the micro-fluidic system. This allows large-shape changes that are required for micro-fluidic applications without the need of any external pump or a micro-pump. Hence, the present invention provides compact micro-fluidic systems. Another, perhaps even more important, advantage is that the fluid can be controlled locally in the micro-channels 33 by addressing all actuator elements 30 at the same time or by addressing only one predetermined actuator element 30 at a time. Therefore, the fluid can be transported, re-circulated, mixed, or separated at a required as well as predetermined position. A further advantage of the present invention is that the use of polymers for the actuator elements 30 may lead to cheap processing technologies such as, for example, printing or embossing techniques, or single-step lithography.

Furthermore, the micro-fluidic system according to the present invention is robust. The performance of the overall micro-fluidic system is not largely disturbed if a single or a few actuator elements 30 fail to work properly.

The micro-fluidic systems according to the invention may be used in biotechnological applications, such as biosensors, rapid DNA separation and sizing, cell manipulation and sorting, in pharmaceutical applications, in high-throughput combinatorial testing where local mixing is essential and in micro-channel cooling systems in microelectronics applications.

The micro-fluidic system of the present invention may be used in biosensors for the detection of at least one target molecule, such as proteins, antibodies, nucleic acids (e.g. DNA, RNA), peptides, oligo- or polysaccharides or sugars and the like, in biological fluids, such as saliva, sputum, blood, blood plasma, interstitial fluid or urine. Therefore, a small sample of the fluid (e.g. a droplet) is supplied to the device, and by manipulation of the fluid within a micro-channel system, the fluid is led to the sensing position where the actual detection takes place. By using various sensors in the micro-fluidic system according to the present invention, different types of target molecules may be detected in one analysis run.

The application of a magnetic field to the magnetic actuator elements 30 may result in translational as well as rotational forces to the actuator elements 30. The rotational force, i.e. the torque on the magnetic actuator element 30, will cause it to move, i.e. to rotate, and/or to change shape. This is illustrated in FIG. 8 for a static, uniform magnetic field applied to the magnetic actuator elements 30 by an external magnetic field-generating means. This magnetic field-generating means can be an electro-magnet, a permanent magnet adjacent to the micro-fluidic system, or an internal magnetic field-generating means such as conductive lines integrated in the micro-fluidic system.

In the situation sketched in FIG. 8, the approaching of the completely erected state will go slower and slower as the angle between the magnetic moment \vec{M} and the magnetic field \vec{H} decreases. This may be solved by rotating the magnetic field during the movement of the actuator element 30.

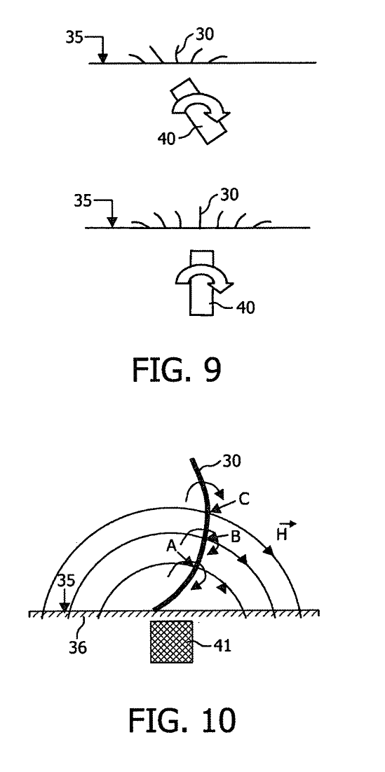

A rotating field applied by a rotating permanent magnet 40 may generate a rotational motion of individual actuator elements 30 and a concerted rolling motion of an array (or a wave) of magnetic actuator elements 30, as schematically illustrated in FIG. 9. In the case of magnetic actuator elements 30 with a permanent magnetic moment, the recovery stroke will occur with actuator element forces oriented towards the surface, so the actuator elements 30 slide over the surface rather than through the bulk of the fluid in the micro-channel 33.

To be able to transport fluid through a micro-channel 33 by the movement of the actuator elements 30 positioned at the inner side 35 of the wall 36 of the micro-channel 33, a certain force and/or magnetic moment must be applied to the surrounding fluid in the micro-channel 33. Instead of using an external magnetic field-generating means such as a permanent magnet or an electromagnet that can be placed outside the micro-fluidic system as described above, another possibility is to use conductive lines 41 that may be integrated in the micro-fluidic system. This is illustrated in FIG. 10. The conductive lines 41 may be copper lines with a cross-sectional area of about 1 to 100 μm². The magnetic field generated by a current through the conductive line 41 decreases with l/r, r being the distance from the conductive line 41 to a position on the actuator element 30. For example, in FIG. 10, the magnetic field will be larger at position A than at position B of the actuator element 30. Similarly, the magnetic field at position B will be larger than the magnetic field at position C of the actuator element 10. Therefore, the polymer actuator element 30 will experience a gradient in magnetic field along its length L. This will cause a “curling” motion of the magnetic actuator element 30, on top of its rotational motion. It can thus be imagined that, by combining a uniform magnetic “far field”, i.e. an externally generated magnetic field which is constant over the whole actuator element 30, the far field being either rotating or non-rotating, with conductive lines 41, it may be possible to create complex time-dependent magnetic fields that enable complex moving shapes of the actuator element 30. This may be very convenient, in particular for tuning the moving shape of the actuator elements 30 so as to get an optimised efficiency and effectiveness in fluid control. A simple example may be that it would enable a tunable asymmetric movement, i.e. the “beating stroke” of the actuator element 30 being different from the “recovery stroke” of the actuator element 30.

The movement of the actuator elements 30 may be measured by one or more magnetic sensors positioned in the micro-fluidic system. This may allow determining flow properties, such as speed and/or viscosity, of the fluid in the micro-channel 33. Furthermore, other details, such as the cell content of the fluid (the hematocrit value), or the coagulation properties of the fluid may be measured by using different actuation frequencies.

An advantage of the above embodiment is that magnetic actuation may be applied to very complex biological fluids, such as e.g. saliva, sputum or full blood. Furthermore, magnetic actuation does not require contacts. In other words, magnetic actuation may be performed in a contactless way. When external magnetic field-generating means are used, the actuator elements 30 are inside the micro-fluidic cartridge, while the external magnetic field-generating means are positioned outside the micro-fluidic cartridge.

It is to be understood that although preferred embodiments, specific constructions and configurations, as well as materials, have been discussed herein for devices according to the present invention, various changes or modifications in form and detail may be made without departing from the scope and spirit of this invention. For example, the change in shape and/or orientation of the actuator elements 30 may lead to a distributed drive of liquid present in the micro-channels 33 of a micro-fluidic system. This could then be modified to be used as a pump. Sequential addressing of actuator elements 30 by means of external stimuli could cause a wave ripple for driving a liquid in one direction in the micro-channel 33. The external stimuli may be an electrical field-generating means. In that case, one or more electrodes, e.g. conducting poly-pyrrole electrodes, can be incorporated in the actuator elements 30. By sequentially addressing the one or more electrodes in the actuator elements 30, the actuator elements 30 can sequentially change their shape and/or orientation. This causes a wave ripple.

1. A micro-fluidic system comprising at least one micro-channel (33) having a wall (36) with an inner side (35), wherein said micro-fluidic system furthermore comprises:
a plurality of actuator elements (30) attached to said inner side (35) of said wall (36), each actuator element (30) having a shape, an orientation and a geometry, said geometry including a varying cross sectional area along a longitudinal axis; and
means for applying stimuli to said plurality of actuator elements (30) so as to cause a change in their shape and/or orientation.

2. A micro-fluidic system according to claim 1, wherein said varying cross sectional area includes one or more openings along said longitudinal axis.

3. A micro-fluidic system according to claim 2, wherein said openings may be in the form of a square, a rectangle, a circle, a semi-circle and/or like shapes.

4. A micro-fluidic system according to claim 1, wherein said varying cross sectional area is substantially towards said inner side (35) of said wall (36) of said micro-channel (33).

5. A micro-fluidic system according to claim 1, wherein said means for applying a stimulus to said plurality of actuator elements (30) is selected from the group comprising an electric field-generating means, an electromagnetic field-generating means, an electromagnetic radiation means, a magnetic field-generating means.

6. A micro-fluidic system according to claim 5, wherein said means for applying a stimulus to said actuator elements (30) is a magnetic field-generating means.

7. A micro-fluidic system according to claim 1, wherein said plurality of actuator elements (30) are arranged in a first and a second row, said first row of actuator elements being positioned at a first position of said inner side (35) of said wall (36) and said second row of actuator elements (30) being positioned at a second position of said inner side (35) of said wall (36), said first position and said second position being substantially opposite to each other.

8. A micro-fluidic system according to claim 1, wherein said plurality of actuator elements (30) are arranged in a plurality of rows of actuator elements (30), which are arranged to form a two-dimensional array.

9. A micro-fluidic system according to claim 1, wherein said plurality of actuator elements (30) is randomly arranged at the inner side (35) of said wall (36).

10. A method for manufacturing a micro-fluidic system comprising at least one micro-channel (33), the method comprising:
providing an inner side (35) of a wall (36) of said at least one micro-channel (33) with a plurality of actuator elements (30) with a geometry, wherein said geometry includes a varying cross sectional area along a longitudinal axis; and
providing means for applying a stimulus to said plurality of actuator elements (30).

11. A method according to claim 10, wherein providing said plurality of actuator elements (30) with said geometry is performed by:
depositing a sacrificial layer having a length L on the inner side (36) of said wall (36);
depositing an actuator material on top of said sacrificial layer; and
releasing said actuator material from said inner side (35) of said wall (36) by removing said sacrificial layer.

12. A method according to claim 10, wherein removing said sacrificial layer is done by performing an etching step.

13. A method according to claim 10, wherein providing means for applying a stimulus to said actuator elements (30) comprises providing a magnetic field-generating means.

14. A method according to claim 10, wherein providing means for applying a stimulus to said actuator elements (30) comprises providing an electric field-generating means.

15. A method for controlling a fluid flow through a micro-channel (33) of a micro-fluidic system, the micro-channel (33) having a wall (36) with an inner side (35), the method comprising:
providing said inner side (35) of said wall (36) with a plurality of actuator elements (30), said actuator elements (30) each having a shape, an orientation and a geometry, wherein said geometry includes a varying cross sectional area along a longitudinal axis; and
applying a stimulus to said actuator elements (30) so as to cause a change in their shape and/or orientation.

16. A method according to claim 15, wherein applying a stimulus to said actuator elements (30) is performed by applying a magnetic field.

17. Use of the micro-fluidic system according to claim 1 in biotechnological, pharmaceutical, electrical or electronic applications.

18. Use of the micro-fluidic system according to claim 1 in a diagnostic device.
